(19) United States
(12) Patent Application Publication
(10) Pub. No.: US 2009/0184976 A1
(43) Pub. Date: Jul. 23, 2009

(54) System and Method for Color-Compensating a Video Signal Having Reduced Computational Requirements

(75) Inventors: Gang Chen, Basking Ridge, NJ (US); Roland Ryf, Aberdeen, NJ (US)

Correspondence Address: HITT GAINES, PC;ALCATEL-LUCENT, PO BOX 832570, RICHARDSON, TX, 75083, US

(73) Assignee: Alcatel-Lucent, Murray Hill, NJ (US)

(21) Appl. No.: 12/017,984

(22) Filed: Jan. 22, 2008

(51) Int. Cl. G09G 5/02

(52) U.S. Cl. 345/604

(57) ABSTRACT

A system for, and method of, color-compensating a video signal. In one embodiment, the system includes: (1) a first transformation circuit configured to receive and transform a gamma-encoded input video signal into a gamma-encoded RGB video signal R′G′B′ and (2) a second transformation circuit coupled to the first transformation circuit and configured to receive and linearly transform the gamma-encoded RGB video signal R′G′B′ into a chrominance-compensated, gamma-encoded rgb video signal r′g′b′.

### TECHNICAL FIELD OF THE INVENTION

The invention is directed, in general, to video signal processing and, more specifically, to a system and method for color-compensating a video signal.

### BACKGROUND OF THE INVENTION

This section introduces aspects that may help facilitate a better understanding of the invention. Accordingly, the statements of this section are to be read in this light and are not to be understood as admissions about what is, or what is not, prior art.

Image or video display systems have been, and continue to be, important devices for presenting visual information. A video display system may take various forms, including a cathode ray tube or a flat-panel display such as a liquid crystal display (LCD) or a plasma display panel (PDP). A video display system may also take the form of a front or rear video projector, which employs a white light source or one or more lasers or light-emitting diode (LEDs) as colored light sources and may include a spatial light modulator (SLM), such as an LCD or a digital mirror device (DMD), to modulate light emanating therefrom. A video signal bearing an ordered sequence of frames is provided to a video display system to cause it to produce a still or moving image. The video signals may be analog or digital and may be encoded according to any one of a variety of standards.

Color video encoding standards define a reference white to exist at a certain temperature and primary colors (usually three) to exist at certain CIE (Commission Internationale d'Eclairage) color coordinates. Standards often define three primary colors that appeal to human eyes: red, green and blue (RGB). Some standards use more than three primary colors. Irrespective of their number or their color coordinates, the primary colors inherently define a “colorspace” within which all colors in all images encoded according to the standard must lie.

As those skilled in the pertinent art understand, video display systems are physical devices and therefore act in accordance with the properties of the materials they use and the physical principles that underlie their operation. These properties and principles skew to some extent the color coordinates of the primary colors they produce. Consequently, the image that a given video display system produces varies in color, or chrominance, from the image the video signal directs. To complicate matters, video display systems may respond nonlinearly to variations in the driving force (e.g., voltage) directly derived from the video signal, causing variations in luminance from what the video signal directs. Further, different types of video display systems use different materials and employ different physical principles and therefore reproduce different images from the same video signal.

A video signal should be precompensated to counteract video display system response. One type of precompensation is directed to counteracting variations in luminance and is called gamma-encoding (also called gamma compensation or gamma compression).

Another type of precompensation counteracts variation in chrominance. The International Electrotechnical Commission (IEC) has issued a standard, 61966-2-4:2006(E) (incorporated herein by reference in its entirety), that sets forth a chrominance precompensation procedure in which a gamma-encoded video signal containing luminance and chrominance components (YCrCb) based on standard primary colors is: (1) transformed into a gamma-encoded signal in a standard RGB colorspace (the signal being referred to as an R′G′B′ signal, the primes denoting that the signal is gamma encoded), (2) then gamma-decoded in the RGB colorspace (the signal then being referred to as an RGB signal), (3) then transformed into a chrominance-compensated colorspace, called rgb, defined by the color coordinates of the video display system's primary colors (the signal then being referred to as an rgb signal), (4) then gamma-reencoded in the rgb colorspace (the signal then being referred to as an r′g′b′ signal) and (5) then finally transformed into a format suitable for the video display system hereinafter called a “system-native format”. Transformations (1) and (5) are usually linear. Transformations (2) and (4) are nonlinear. Transformation (3) is linear.

### SUMMARY OF THE INVENTION

To address the above-discussed deficiencies of the prior art, one aspect of the invention provides a system for color-compensating a video signal. In one embodiment, the system includes: (1) a first transformation circuit configured to receive and transform a gamma-encoded input video signal into a gamma-encoded RGB video signal R′G′B′ and (2) a second transformation circuit coupled to the first transformation circuit and configured to receive and linearly transform the gamma-encoded RGB video signal R′G′B′ into a chrominance-compensated, gamma-encoded rgb video signal r′g′b′. The first and second transformation circuits may be combined into a single transformation circuit that performs a single linear transformation.

Another aspect of the invention provides a method of color-compensating a video signal. In one embodiment, the method includes: (1) transforming a gamma-encoded input video signal into a gamma-encoded RGB video signal R′G′B′ and (2) linearly transforming the gamma-encoded RGB video signal R′G′B′ into a chrominance-compensated, gamma-encoded rgb video signal r′g′b′. The transforming and the linearly transforming may be carried out in with a single transform.

Yet another aspect of the invention provides a video display system. In one aspect, the system includes: (1) an input configured to receive a gamma-encoded input video signal, (2) a first transformation circuit configured to receive and transform the gamma-encoded input video signal into a gamma-encoded RGB video signal R′G′B′, (3) a second transformation circuit coupled to the first transformation circuit and configured to receive and linearly transform the gamma-encoded RGB video signal R′G′B′ into a chrominance-compensated, gamma-encoded rgb video signal r′g′b′ and (4) a third transformation circuit coupled to the second transformation circuit and configured to receive and transform the chrominance-compensated, gamma-encoded rgb video signal r′g′b′ into a system-native luma-chroma-chroma format. (Luma is used herein to designate gamma-compensated luminance, and chroma is used herein as a synonym of chrominance.)

### BRIEF DESCRIPTION OF THE DRAWINGS

For a more complete understanding of the invention, reference is now made to the following descriptions taken in conjunction with the accompanying drawings, in which:

FIG. 1A illustrates a block diagram of one environment within which a system for color-compensating a video signal may operate;

FIG. 1B is a block diagram of one embodiment of the color-compensating system of FIG. 1A;

FIGS. 2A and 2B are chrominance charts in Cx Cy space corresponding to a frame of a video signal before and after a color-compensating transformation;

FIG. 3A is a luminance and chrominance chart in Y Cx Cy space illustrating changes occurring in a video image of a video signal between no transformation and a substantially exact transformation carried out according to a known compensation standard;

FIG. 3B is a luminance and chrominance chart in Y Cx Cy space illustrating changes occurring in a video image of a video signal as between a transformation having reduced computational requirements and a substantially exact transformation carried out according to a known compensation standard; and

FIG. 4 is a flow diagram of one embodiment of a method for color-compensating a video signal having reduced computational requirements.

### DETAILED DESCRIPTION OF ILLUSTRATIVE EMBODIMENTS

The chrominance precompensation procedure of IEC 61966-2-4:2006(E) counteracts system chrominance variation and is therefore regarded as a substantially exact solution. However, the many and varied transformations it requires are computationally intensive, requiring a large hard-wired logic circuit, a powerful processor or both. Such circuits or processors are relatively large and power consumptive.

What is needed in the art is a less computationally intensive way to color-compensate a video signal. What is also needed in the art is a way to color-compensate a video signal that perhaps allows logic circuit or processor size to be reduced and perhaps reduces the amount of power consumed performing such compensation.

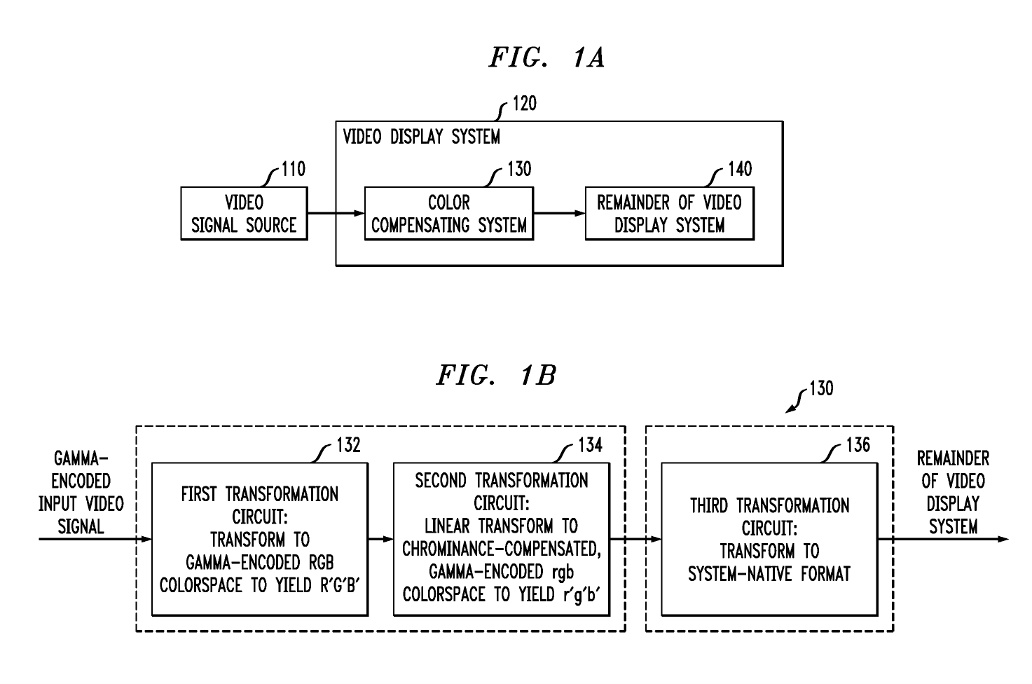

FIG. 1A illustrates a block diagram of one environment within which a system for color-compensating a video signal may operate. A video signal source 110 provides a video signal, which may be an analog or digital video signal generated according to any conventional or later-developed standard, to a video display system 120. The video display system 120 includes a color compensating system 130 and a remainder 140, which may be a cathode ray tube, a flat-panel display or a video projector. In the illustrated embodiment, the remainder is a video projector. In a more specific embodiment, the remainder is a video projector using a liquid crystal on silicon (LCoS) panel as the spatial light modulator (referred to as an “LCD video projector”).

In a yet more specific embodiment, the LCD video projector employs several lasers or LEDs as colored light sources and one or more associated drivers that provide power or control to the light sources. An example of a driver suitable for the yet more specific embodiment can be found in U.S. patent application Ser. No. [Attorney Docket No. G. Chen 14-1-24], filed by Gang Chen, David A. Duque, and Roland Ryf on even date herewith, entitled “Time Division Multiplexing a DC-to-DC Voltage Converter” and incorporated herein by reference in its entirety. Since lasers or LEDs produce coherent light, speckle, which degrades projector performance, may result. Accordingly, in another, more specific embodiment, the LCD video projector employs a diffuser or one or more other optical components to reduce speckle. An example of such a diffuser can be found in U.S. patent application Ser. No. [Attorney Docket No. G. Chen 12-22], filed by Gang Chen and Roland Ryf on even date herewith, entitled “Diffuser Configuration for an Image Projector” and incorporated herein by reference in its entirety.

In a still more specific embodiment, the LCD video projector is battery- or wall-plug powered and configured to produce enhanced brightness with the color compensating system 130 embodied as an IC in the integrated driving/control circuit of the LCD projector. An example of an LCD with enhanced brightness can be found in U.S. patent application Ser. No. [Attorney Docket No. G. Chen 13-23], filed by Gang Chen and Roland Ryf on even date herewith, entitled “Multi-Color Light Source” and incorporated herein by reference in its entirety. In yet another specific embodiment, the color compensation system 130 is embodied in an integrated, SLM-based video projector. Integrated, SLM-based video projectors are described in general in U.S. patent application Ser. No. 11/713,207, filed by R. Giles, et al., on Mar. 2, 2007, entitled “Direct Optical Image Projectors” and incorporated herein by reference in its entirety.

Although not necessary, the battery-powered, IC-embodied LCD video projector may be part of a larger, battery-powered device, such as a personal digital assistant (PDA), an audio (e.g., MP3) player, a digital camera or a cell phone.

As described above, standards-based chrominance precompensation procedures, while substantially exact, are often computationally complex. The disclosure is directed in general to reducing computational requirements. As a result, the size of the hard-wired digital logic or processor required to perform color compensation may be reduced. Further, the power required to perform such color compensation may be reduced. These are potentially advantageous in the context of the battery-powered devices listed above and other such devices. In general, reduced logic circuit or processor size yield lower manufacturing cost, and reduced power requirements yield lower heat dissipation, so such color compensation may find significant advantage in a wide variety of larger, non-battery-powered conventional or later developed video display systems.

In general, the color compensation system 130 transforms the video signal emanating from the video signal source 110 into a system-native format that is both gamma-encoded and at least approximately precompensated for any variations in chrominance that the remainder of the video display system 140 may contain.

As described above, IEC 61966-2-4:2006(E) sets forth a chrominance precompensation procedure in which a gamma-encoded video signal is transformed into an R′G′B′ colorspace, is then gamma-decoded into a RGB colorspace, is then transformed into a chrominance-compensated rgb colorspace, is then gamma-reencoded into a chrominance-compensated r′g′b′ colorspace and is finally transformed into the system-native format. This procedure yields a substantially exact solution, which those skilled in the art prefer for accuracy of color rendition.

However, it has been found that the computational requirements of the substantially exact, standards-based procedure may be significantly reduced without a concomitant significant loss in accuracy of color rendition by eliminating the gamma decoding and subsequent encoding steps. Those skilled in the pertinent art know that, while gamma may vary from one type of video display system to another or one particular video display system to another, it is always a nonlinear function. Thus, gamma encoding and decoding require nonlinear transforms (sometimes carried out by means of lookup tables) and are therefore responsible for a significant portion of the overall computational requirements of the standards-based chrominance precompensation procedure. It has therefore been found that color compensation can be carried out with approximate, but typically highly acceptable color rendition accuracy, in the rgb colorspace. A single linear transform can achieve such an approximate color compensation.

FIG. 1B is a block diagram of one embodiment of the color-compensating system 130 of FIG. 1A. The system includes an input (not referenced) configured to receive a gamma-encoded input video signal. A first transformation circuit 132 is configured to receive and transform the gamma-encoded input video signal into a gamma-encoded RGB video signal R′G′B′. In the illustrated embodiment, the gamma-encoded input video signal is a luma-chroma-chroma (Y′Cr′Cb′, or simply YCC) video signal. Examples include YCC₆₀₁, implemented mainly in standard-definition television (see, International Telecommunication Union, or ITU, standard ITU-R BT.601-6, incorporated herein by reference in its entirety), or YCC₇₀₉, implemented mainly in high-definition television (see, ITU standard ITU-R BT-709.5, incorporated herein by reference in its entirety). Because the input video signal is a YCC video signal, the transformation performed by the first transformation circuit 132 is a linear transformation. For example, ITU-R BT.601-6 relates R′G′B′ to YCC₆₀₁ as follows:

$$[ \begin{matrix}{R}^{′} \\ {G}^{′} \\ {B}^{′}\end{matrix} ] = [ \begin{matrix}1.0000 & 0.0000 & 1.4020 \\ 1.0000 & - 0.3441 & - 0.7141 \\ 1.0000 & - 1.7720 & 0.0000\end{matrix} ] [ \begin{matrix}{Y}_{601}^{′} \\ {Cr}_{601}^{′} \\ {Cb}_{601}^{′}\end{matrix} ] ,$$

and ITU-R BT.709-5 relates R′G′B′ to YCC₇₀₉ as follows:

$$[ \begin{matrix}{R}^{′} \\ {G}^{′} \\ {B}^{′}\end{matrix} ] = [ \begin{matrix}1.0000 & 0.0000 & 1.5748 \\ 1.0000 & - 0.1873 & - 0.4681 \\ 1.0000 & - 1.8556 & 0.0000\end{matrix} ] [ \begin{matrix}{Y}_{709}^{′} \\ {Cr}_{709}^{′} \\ {Cb}_{709}^{′}\end{matrix} ]$$

For input video signal that does not follow the above mentioned standard, the video signal can be transformed into R′G′B′ using other specific transformations. The input video signal may already be a gamma-encoded signal R′G′B′ in RGB space, in which case the above transformation would not be carried out. The input video signal may not be digital, but rather a composite analog video signal, for example. In such case, the analog video signal would be digitized before being transformed into R′G′B′.

A second transformation circuit 134 is coupled to the first transformation circuit 132 and is configured to receive and linearly transform the gamma-encoded RGB video signal R′G′B′ into a chrominance-compensated, gamma-encoded rgb video signal r′g′b′. The general form for this second linear transformation is:

$$[ \begin{matrix}{r}^{′} \\ {g}^{′} \\ {b}^{′}\end{matrix} ] = [ \begin{matrix}{a}_{1 , 1} & {a}_{1 , 2} & {a}_{1 , 3} \\ {a}_{2 , 1} & {a}_{2 , 2} & {a}_{2 , 3} \\ {a}_{3 , 1} & {a}_{3 , 2} & {a}_{3 , 3}\end{matrix} ] [ \begin{matrix}{R}^{′} \\ {G}^{′} \\ {B}^{′}\end{matrix} ]$$

The values of a_{i,j} i=1,2,3,j=1,2,3 depend upon specific system characteristics, namely the distances separating the system's primary colors from those of the standard. For example, if the system's primary colors are the same as those of the standard (the distances separating them are 0), all a_{i,j} equal 1. Those skilled in the pertinent art are able to determine a_{i,j} given R′, G′, B′, r′, g′and b′.

It is important to note that no material transformation circuits or transformation processes exist or are undertaken between the first and second transformation circuits 132, 134. It is also important to note that, if the transformation performed by the first transformation circuit 132 is a linear transformation, the first and second transformation circuits 132, 134 may be combined into a single transformation circuit that performs a single linear transformation that directly transforms the gamma-encoded input video signal R′G′B′ into color-compensated r′g′b′. A broken-line box (unreferenced) surrounding the first and second transformation circuits 132, 134 represents this possibility.

A third transformation circuit 136 is coupled to the second transformation circuit 134 and is configured to receive and transform the chrominance-compensated, gamma-encoded rgb video signal r′g′b′ into a system-native format for the benefit of the remainder of the video display system, as shown. In the illustrated embodiment, the system-native format is a luma-chroma-chroma format (hereinafter called ycc), meaning that the transformation performed by the third transformation circuit 136 is a linear transformation. For example, ITU-R BT.601-6 relates ycc₆₀₁ to r′g′b′ as follows:

$$[ \begin{matrix}{y}_{601}^{′} \\ {cr}_{601}^{′} \\ {cb}_{601}^{′}\end{matrix} ] = [ \begin{matrix}0.2990 & 0.5870 & 0.1140 \\ - 0.1687 & - 0.3313 & - 0.5000 \\ 0.5000 & - 0.4187 & - 0.0813\end{matrix} ] [ \begin{matrix}{r}^{′} \\ {g}^{′} \\ {b}^{′}\end{matrix} ] ,$$

and ITU-R BT.709-5 relates ycc₇₀₉ to r′g′b′ as follows:

$$[ \begin{matrix}{y}_{709}^{′} \\ {cr}_{709}^{′} \\ {cb}_{709}^{′}\end{matrix} ] = [ \begin{matrix}0.2126 & 0.7152 & 0.0722 \\ - 0.1146 & - 0.3854 & - 0.5000 \\ 0.5000 & - 0.4542 & - 0.0458\end{matrix} ] [ \begin{matrix}{r}^{′} \\ {g}^{′} \\ {b}^{′}\end{matrix} ] .$$

Those skilled in the art understand that, if the system-native format is other than ycc, other specific transformations exist to transform from r′g′b′ into the system-native format.

If the transformation performed by the third transformation circuit 136 is a linear transformation, the first, second and third transformation circuits 132, 134, 136 may be combined into a single transformation circuit that performs a single linear transform that directly transforms the gamma-encoded input video signal into the system-native format. The broken-line box (unreferenced) surrounding the first and second transformation circuits 132, 134 may extend to encompass the third transformation circuit 136, as shown, and represents this further possibility. The third transformation circuit 136 is unnecessary if the system-native format is r′g′b′.

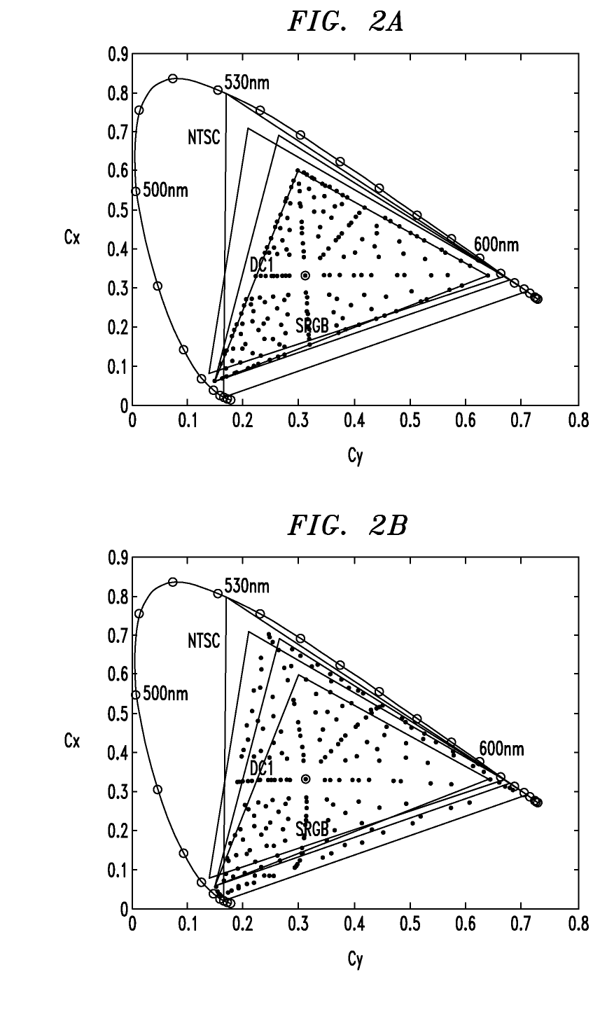

FIGS. 2A and 2B are chrominance charts in Cx Cy space corresponding to a frame of a video signal before (FIG. 2A) and after (FIG. 2B) a color-compensating transformation. The frame is strictly an example for purposes of illustration. Its specific content is unimportant, but it contains a range of colors and serves to demonstrate the effects of color correction carried out either substantially exactly according to known standards or approximately according to the teachings hereof. Only certain pixels in the frame are illustrated for simplicity's sake. FIGS. 2A and 2B are presented primarily for the purpose of showing that the chrominance of the video image is shifted to a new, system-dependent colorspace by virtue of the direct R′G′B′-to-r′g′b′ linear transformation described herein.

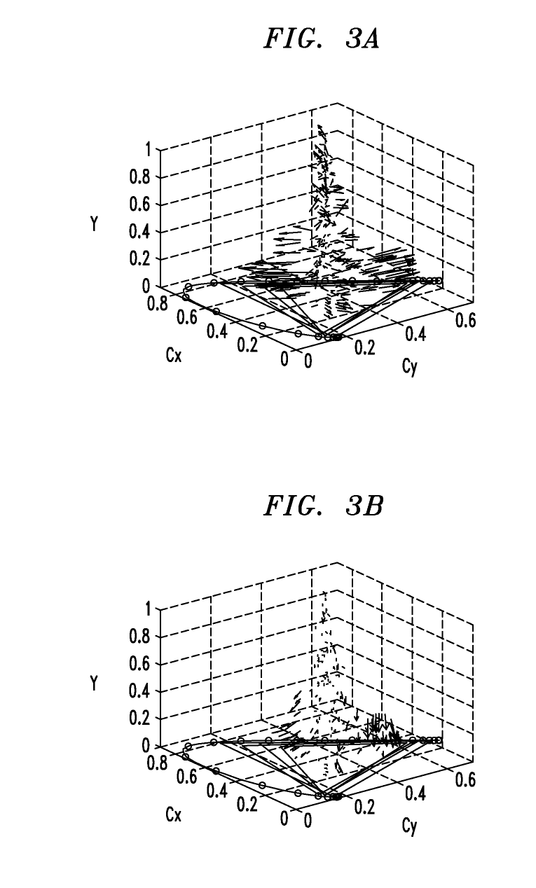

FIG. 3A is a luminance and chrominance chart in Y Cx Cy space illustrating changes occurring in a video image of a video signal between no transformation and a substantially exact transformation carried out according to a known compensation standard. FIG. 3B is a luminance and chrominance chart in Y Cx Cy space illustrating changes occurring in a video image of a video signal as between a transformation having reduced computational requirements and a substantially exact transformation carried out according to a known compensation standard. Vectors in FIGS. 3A and 3B illustrate the changes. Again, only certain pixels in the frame are illustrated for simplicity's sake. It is apparent that, while some differences exist between the substantially exact color correction mandated by standards and the approximate color correction taught herein (FIG. 3B), those differences are minor compared to the differences that existed before any color correction took place (FIG. 3A). It is therefore apparent that the system described herein not only substantially precompensates chrominance but can also significantly reduce computational requirements relative to the standards-based chrominance precompensation procedure.

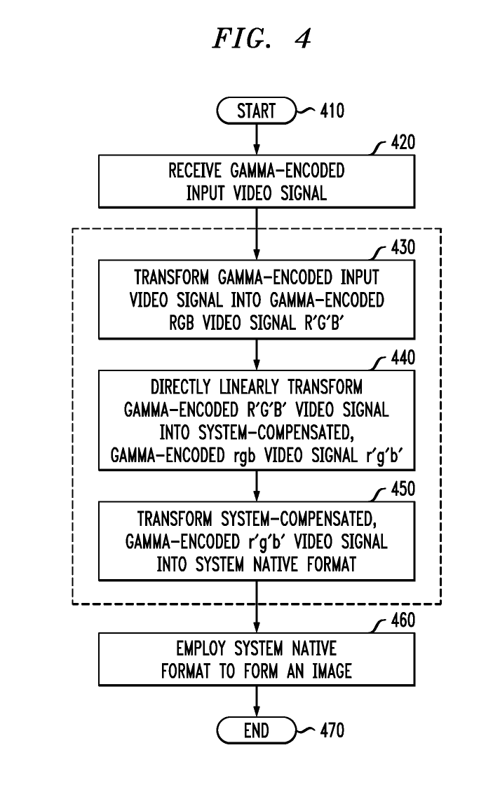

FIG. 4 is a flow diagram of one embodiment of a method for color-compensating a video signal having reduced computational requirements. The method begins in a start step 410. In a step 420, a gamma-encoded input video signal is received. In one embodiment, the input video signal is a standard, digital, luma-chroma-chroma (YCC) video signal. In a step 430, the gamma-encoded input video signal is transformed into a gamma-encoded RGB video signal R′G′B′. If the input video signal is a luma-chroma-chroma (YCC) video signal, the transformation of the step 430 is a linear transform. In a step 440, the gamma-encoded RGB video signal R′G′B′ is linearly transformed into a chrominance-compensated, gamma-encoded rgb video signal r′g′b′. No material transformations of the data are undertaken between the steps 430 and 440. It is also important to note that, if the transformation carried out in the step 430 is a linear transform, the steps 430, 440 may be combined, in some embodiments, into a single step that directly transforms the gamma-encoded input video signal into the chrominance-compensated, gamma-encoded rgb video signal r′g′b′ A broken-line box surrounding the steps 430, 440 represents this embodiment. Further, if the transformation carried out in the step 450 is a linear transform, the steps 430, 440, 450 may be combined into a single step that performs a single linear transformation that directly transforms the gamma-encoded input video signal into the system-native format (ycc-type data). The broken-line box (unreferenced) surrounding the steps 430, 440 may extend to encompass the step 450, as shown, and represents this further embodiment.

In a step 450, the chrominance-compensated, gamma-encoded rgb video signal r′g′b′ is transformed into a system-native format. In one embodiment, the system-native format is a digital, luma-chroma-chroma format (ycc). In a step 460, the system-native format is employed in a video display system to form an image. In one embodiment, the video display system is a battery-powered LCD projector. The method ends in an end step 470.

The above-described methods may be performed by various conventional digital data processors or computers, wherein the computers are programmed or store executable programs of sequences of software instructions to perform one or more of the steps of the methods, e.g., steps of the method of FIG. 4. The software instructions of such programs may be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., one or more of the steps of the method of FIG. 4.

Those skilled in the art to which the invention relates will appreciate that other and further additions, deletions, substitutions and modifications may be made to the described embodiments without departing from the scope of the invention.

What is claimed is:

1. A system for color-compensating a video signal, comprising:
a first transformation circuit configured to receive and transform a gamma-encoded input video signal into a gamma-encoded RGB video signal R′G′B′; and
a second transformation circuit coupled to said first transformation circuit and configured to receive and linearly transform said gamma-encoded RGB video signal R′G′B′ into a chrominance-compensated, gamma-encoded rgb video signal r′g′b′.

2. The system as recited in claim 1 wherein said input video signal contains luma and chroma components.

3. The system as recited in claim 1 further comprising a third transformation circuit coupled to said second transformation circuit and configured to receive and transform said chrominance-compensated, gamma-encoded rgb video signal r′g′b′ into a system-native format.

4. The system as recited in claim 3 wherein said system-native format contains luma and chroma components.

5. The system as recited in claim 1 wherein said first and second transformation circuits are embodied in a selected one of:
at least one hard-wired logic circuit, and a sequence of software instructions executable in a processor.

6. The system as recited in claim 1 wherein said system is a portion of a video display system and is embodied in an integrated circuit and other parts of said video display system.

7. The system as recited in claim 1 wherein said chrominance-compensated, gamma-encoded rgb video signal r′g′b′ is chrominance-compensated for a liquid crystal display (LCD)-based video projector.

8. A method of color-compensating a video signal, comprising:
transforming a gamma-encoded input video signal into a gamma-encoded RGB video signal R′G′B′; and
linearly transforming said gamma-encoded RGB video signal R′G′B′ into a chrominance-compensated, gamma-encoded rgb video signal r′g′b′.

9. The method as recited in claim 8 wherein said input video signal contains luma and chroma components.

10. The method as recited in claim 8 further comprising transforming said chrominance-compensated, gamma-encoded rgb video signal r′g′b′ into a system-native format.

11. The method as recited in claim 10 wherein said system-native format contains luma and chroma components.

12. The method as recited in claim 8 wherein said transforming and said linearly transforming are carried out in a selected one of:
at least one hard-wired logic circuit, and
a sequence of software instructions executable in a processor.

13. The method as recited in claim 8 wherein said method is carried out in a video display system embodied in an integrated circuit.

14. The method as recited in claim 8 wherein said chrominance-compensated, gamma-encoded rgb video signal r′g′b′ is chrominance-compensated for a liquid crystal display (LCD)-based video projector.

15. A video display system, comprising:
an input configured to receive a gamma-encoded input video signal;
a first transformation circuit configured to receive and transform said gamma-encoded input video signal into a gamma-encoded RGB video signal R′G′B′;
a second transformation circuit coupled to said first transformation circuit and configured to receive and linearly transform said gamma-encoded RGB video signal R′G′B′ into a chrominance-compensated, gamma-encoded rgb video signal r′g′b′; and
a third transformation circuit coupled to said second transformation circuit and configured to receive and transform said chrominance-compensated, gamma-encoded rgb video signal r′g′b′ into a system-native luma-chroma-chroma format.

16. The system as recited in claim 15 wherein said input video signal contains luma and chroma components.

17. The system as recited in claim 15 wherein said first, second and third transformation circuits are embodied in a selected one of:
at least one hard-wired logic circuit, and
a sequence of software instructions executable in a processor.

18. The system as recited in claim 15 wherein said system is embodied in an integrated circuit.

19. The system as recited in claim 15 wherein said system is a liquid crystal display (LCD)-based video projector.
